(19) United States
(12) Patent Application Publication
(10) Pub. No.: US 2018/0109046 A1
(43) Pub. Date: Apr. 19, 2018

(54) Fuse Structure for a Plug Device

(71) Applicant: Cord-It Limited, Kowloon, Hong Kong (CN)

(72) Inventor: Hing Wai Michael Ma, Kowloon, Hong Kong (CN)

(21) Appl. No.: 15/517,295

(22) PCT Filed: Oct. 8, 2015
(86) PCT No.: PCT/CN2015/091492

§ 371 Date: May 31, 2017

(30) Foreign Application Priority Data
Oct. 7, 2014 (HK) 14109992.3

(51) Int. Cl. H01R 13/692; H01R 24/30; H01R 31/06; H01R 35/04; H01R 13/447; H01H 85/54

(52) U.S. Cl. CPC H01R 13/692; H01R 24/30; H01H 85/545; H01R 35/04; H01R 13/447; H01R 31/06

(57) ABSTRACT

A fuse structure for a plug device is disposed in a body of the plug device and configured to be electrically connected to a plug circuit of the plug device. The plug device includes at least one casing for exposing a pin, in which an assembly chamber for a fuse and a cover are disposed below the casing. A horizontal slot for the fuse is disposed in the fuse assembly chamber, and the cover is configured cover the assembly chamber for the fuse. A pivot shaft of the cover is disposed adjacent to an articulating shaft of the casing, and the cover is prevented from being opened by the casing when the casing is unfolded.

### FIELD

The present disclosure relates to a plug device, more particularly to an improvement of a fuse structure for a plug device.

### BACKGROUND

As to a plug device in the prior art, a fuse is generally electrically connected to a power-gaining circuit, which will fuse timely to cut off the circuit when the power-gaining circuit is short-circuited and in other dangerous states, thus achieving a safety function. According to the requirements of ordinances in certain areas, such as Hong Kong, the fuse cannot be replaced when a plug or a socket is in use, in order to achieve the safety function. In the conventional socket device, an assembly position of the fuse is usually disposed in an inserting surface of the plug, such that the fuse cannot be replaced during inserting connection.

However, a conventional plug device, in particular a plug device with three pins generally occupies a large volume, resulting in inconvenient store and carry, and the plugs are easy to damage. Some improved technologies are proposed for this situation, that is, the structure of the plug device in the prior art is improved to be foldable, such that the volume is reduced in idle, and the whole plug device is unfolded only in use. In this case, it is hard to adopt the fuse structure that the fuse is disposed in the inserting surface to comply with the above requirements of ordinances. Since the improved plug device has a small volume, the difficulty of the disposition of the fuse structure sharply increases, which is a hard issue to be solved for those skilled in the art.

Therefore, on the plug device in the prior art there is room for improvement and development.

### SUMMARY

A fuse structure for a plug device is configured such that the fuse cannot be replaced when a plug device having a small volume is in use to ensure the safety.

The technical solution according to the present disclosure is as follows.

A fuse structure for a plug device is disposed in a body of the plug device and configured to be electrically connected to a plug circuit of the plug device. The plug device includes at least one casing for exposing a pin, in which an assembly chamber for a fuse and a cover are disposed below the casing. A horizontal slot for the fuse is disposed in the fuse assembly chamber, and the cover is configured to cover the assembly chamber for the fuse. A pivot shaft of the cover is disposed adjacent to an articulating shaft of the casing, and the cover is prevented from being opened by the casing when the casing is unfolded.

According to some embodiments of the present disclosure, the plug device includes a pin module having at least one fixed pin and disposed in an inserting direction. The articulating shaft of the casing is configured to be a first articulating shaft disposed in a bottom of the pin module, and the casing is configured to have two casings, including a first casing and a second casing, disposed to two sides of the pin module and rotatable about the first articulating shaft. A slot is disposed in a middle portion of the first casing. A movable pin corresponding to the fixed pin is disposed to the second casing, and the movable pin is configured such that the movable pin is located in the slot when the two casings are folded, and the movable pin is turned out of the slot when the two casings are unfolded, to form a plug cooperating with the fixed pin.

According to some embodiments of the present disclosure, a rotatable second articulating shaft is disposed in a bottom of the movable pin, a third articulating shaft is disposed at a predetermined distance from the second articulating shaft, and a pull tab articulated with the third articulating shaft is disposed to an inner sidewall of the second casing. The movable pin is L-shaped, and the second articulating shaft and the third articulating shaft are located in an end of a bottom of the L-shaped movable pin.

According to some embodiments of the present disclosure, the pull tab is connected to the inner sidewall of the second casing through a fourth articulating shaft.

According to some embodiments of the present disclosure, two fixed pins are provided, and the fixed pins and the movable pin are configured as BS pins of Hong Kong standard.

According to some embodiments of the present disclosure, an elastic element for unfolding the first casing and the second casing is disposed around the first articulating shaft and between the first casing and the second casing.

According to some embodiments of the present disclosure, the elastic element is configured as a coil spring, and two legs of the elastic element are fixed on the first casing and the second casing respectively.

According to some embodiments of the present disclosure, a button is disposed on a sidewall of the first casing, and configured to release a snap-fit structure for folding the first casing and the second casing when pressed. The snap-fit structure includes a resilient snap protrusion at a corresponding position of the second casing, and a press portion on a bottom surface of the button and configured to be fitted with the resilient snap protrusion.

According to some embodiments of the present disclosure, the plug device is further provided with a power storage unit.

According to some embodiments of the present disclosure, the plug device is further provided with at least one USB power output.

With the fuse structure for the plug device according to the present disclosure, the assembly chamber for the fuse is disposed below the casing, and the cover of the assembly chamber for the fuse is prevented from being opened by the casing when the casing is unfolded, such that the assembly chamber for the fuse is ensured to be covered by means of the cover when the casing is in a unfolded state and the plug device is in use, and further the fuse cannot be exposed and replaced in use.

### BRIEF DESCRIPTION OF THE DRAWINGS

FIGS. 1a and 1b are perspective views of a plug device according to a first preferred embodiment of the present disclosure.

FIGS. 2a and 2b are perspective views of a plug device according to a second preferred embodiment of the present disclosure.

FIG. 3 is a perspective view of a plug device according to a third preferred embodiment of the present disclosure.

FIGS. 4a and 4b are partial exploded views of a plug device according to the present disclosure.

FIGS. 5a and 5b are partial perspective views of a plug device according to the present disclosure.

### DETAILED DESCRIPTION

The preferred embodiments of the present disclosure are illustrated in detail below.

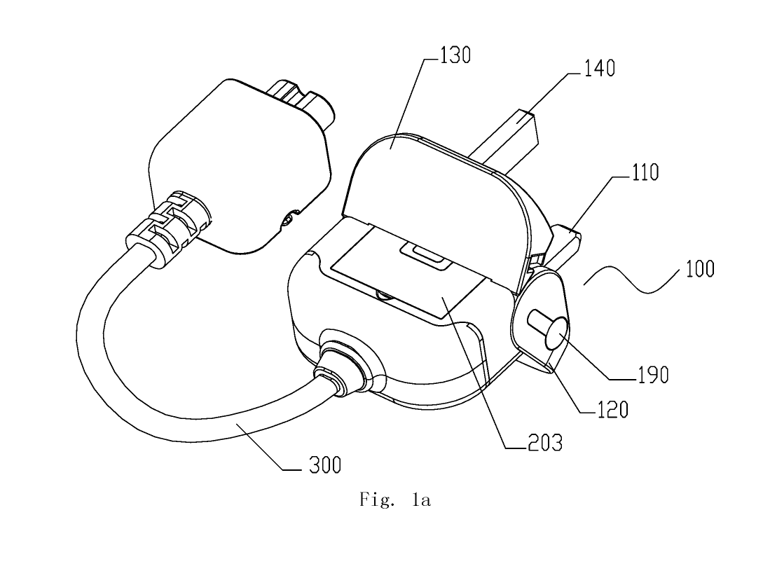

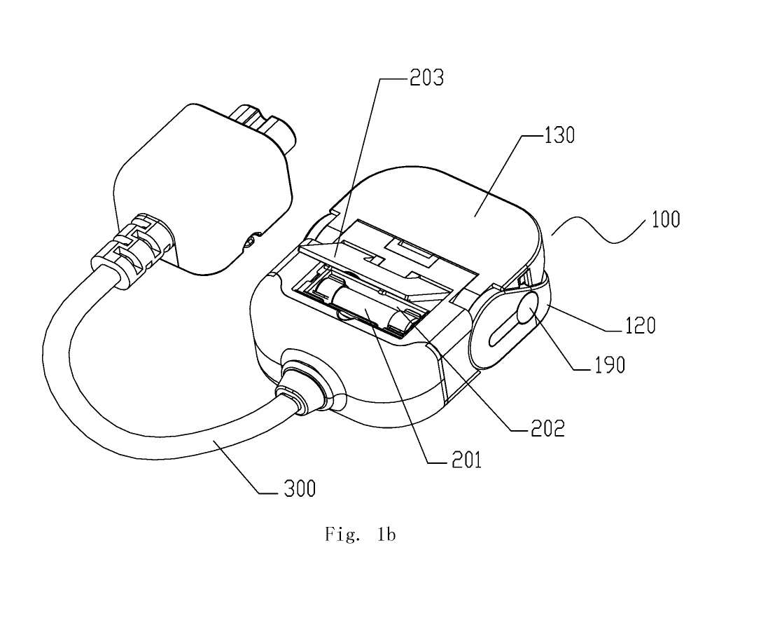

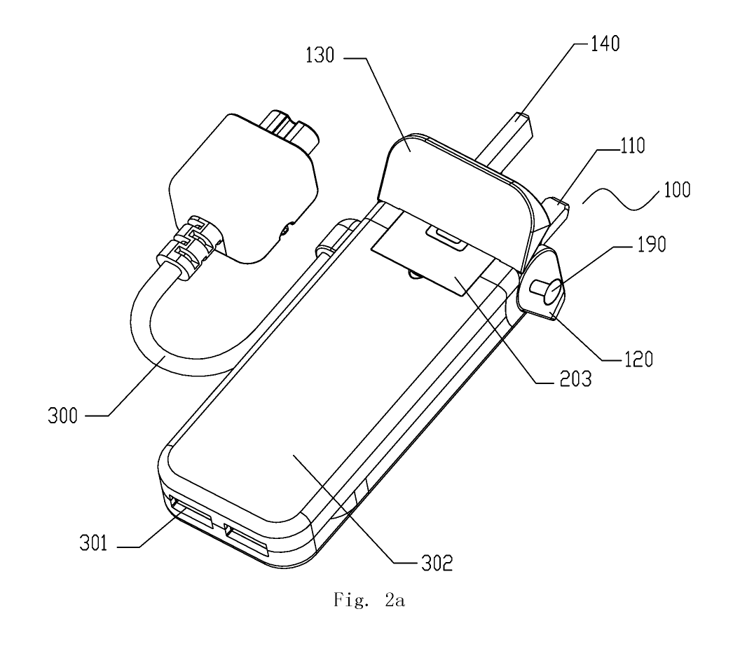

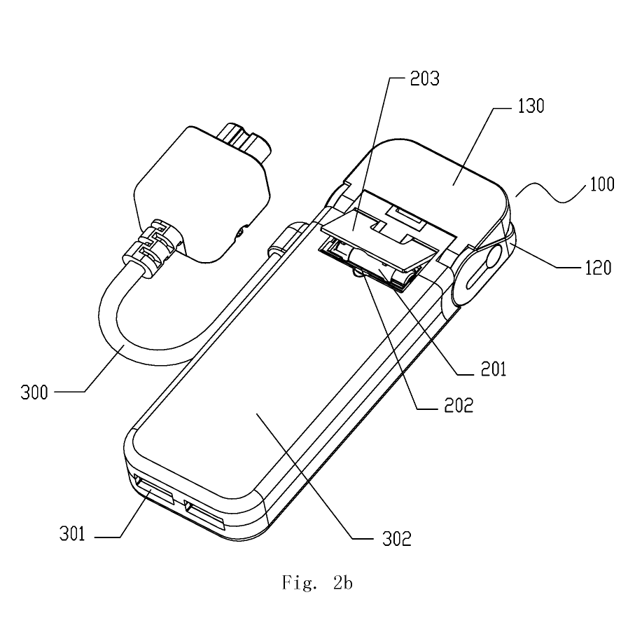

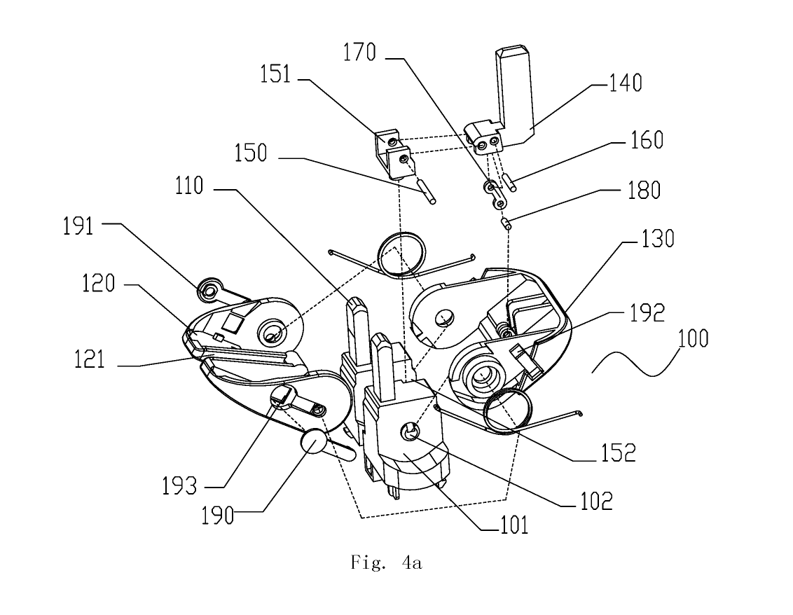

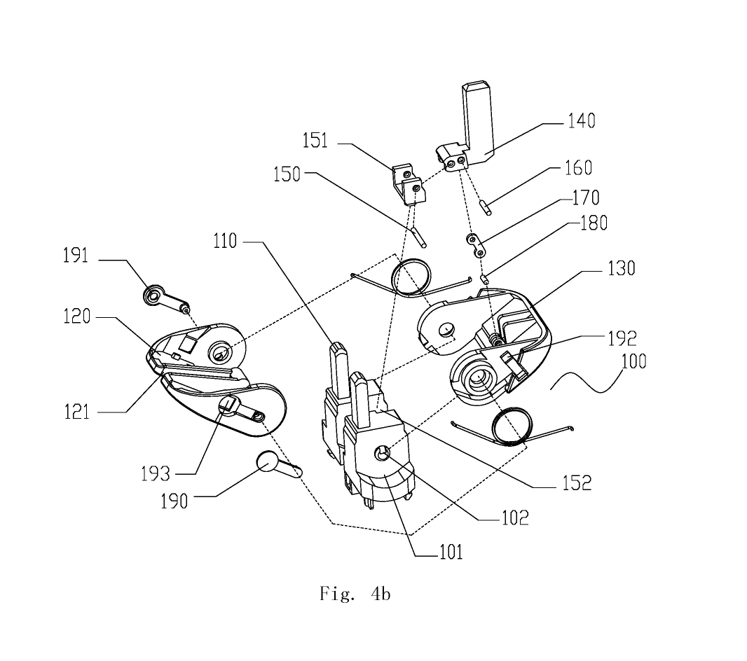

A fuse structure for a plug device according to the present disclosure, in a first embodiment shown in FIGS. 1a and 1b, is disposed in a foldable plug device 100 which generally has at least one foldable casing 120 or 130 (only the casing 130 is illustrated). The plug device of the present disclosure includes a pin module 101 having at least one fixed pin 110, as shown in FIGS. 4a and 4b. One or two fixed pins 110 may be provided and configured to be pins of different standards. The plugs according to various embodiments of the present disclosure illustrated in the accompanying drawings are configured as British plugs which conform to Hong Kong standard. The fuse structure according to the present disclosure is disposed in a body of the plug device 100, and an internal circuit thereof is electrically connected to a plug circuit to prevent the plug circuit from being short-circuited and in other dangerous situations, such that the circuit may be cut off timely when the dangerous situations occur. As shown in FIGS. 1b and 2b, an assembly chamber 202 for a fuse is disposed in the body of the plug device 100. A horizontal slot for the fuse 201 is provided therein. A cover 203 is disposed to the assembly chamber 202 and used to cover the assembly chamber 202, such that the whole assembly chamber is hidden in the body of the plug device 100.

In the fuse structure for the plug device according to the present disclosure, a pivot shaft of the cover 203 is disposed adjacent to an articulating shaft of the casing 120 or 130, i.e. a first articulating shaft 102 (as shown in FIGS. 4a and 4b), and the position of the pivot shaft is sufficient to ensure that the cover 203 may be prevented from being opened when the casing is unfolded, as shown in FIGS. 1a and 2a. Preferably, the unfolded casing is just pressed against the cover 203, such that the cover 203 cannot be opened, thus satisfying the requirement that the fuse cannot be opened and replaced when the plug is plugged in. The obstructive effect ensures that the fuse structure cannot be opened when the plug device is plugged in, while the cover only can be opened when the plug device is folded in idle. Although a user may open the cover when the plug device is in the folded state, the action of unfolding the plug device forcibly closes the cover of the assembly chamber for the fuse by means of the casing, such that it is ensured that the cover for the fuse is forcibly held in the closed state when the plug is in use.

In the plug device 100 according to the present disclosure, as shown in FIGS. 4a and 4b, the pin module 101 is fixedly disposed in an inserting direction, the articulating shaft i.e. the first articulating shaft 102 is disposed in a bottom of the pin module, and two casings, including a first casing 120 and a second casing 130, which are rotatable about the first articulating shaft are articulated through the first articulating shaft 102. A slot 121 is disposed in a middle position of the first casing 120, and the slot 121 is arranged at a place where a movable pin can be conveniently turned. The movable pin 140 is configured to adopt a turnable structure, such that the movable pin 140 is located in the slot 121 when the two casings 120, 130 are in a folded state, and the movable pin 140 is turned out of the slot 121 when the two casings are in an unfolded state to form a plug cooperating with the fixed pin 110.

Therefore, the pin structure can be conveniently turned, and the two casings may be folded in idle, such that the volume thereof is reduced, and it is convenient to carry, and while the two casings may be unfolded in use, such that the movable pin may be turned and extend out to form an available plug structure.

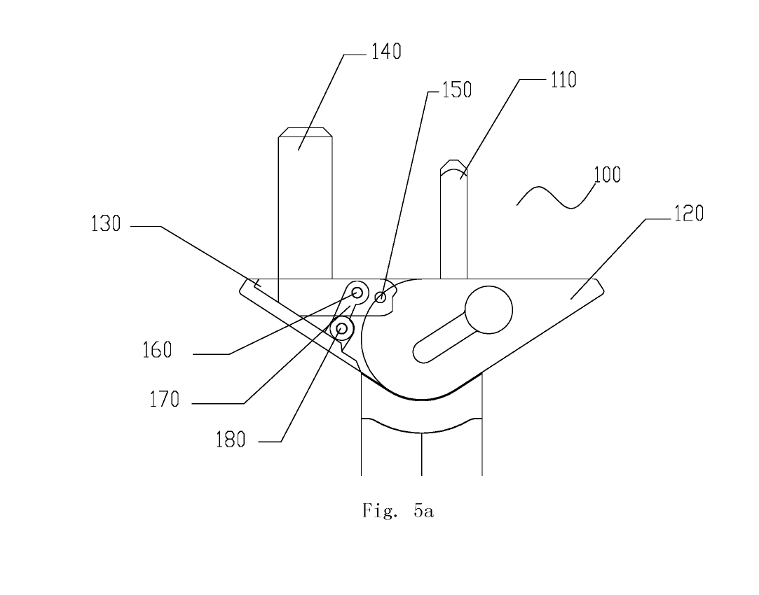

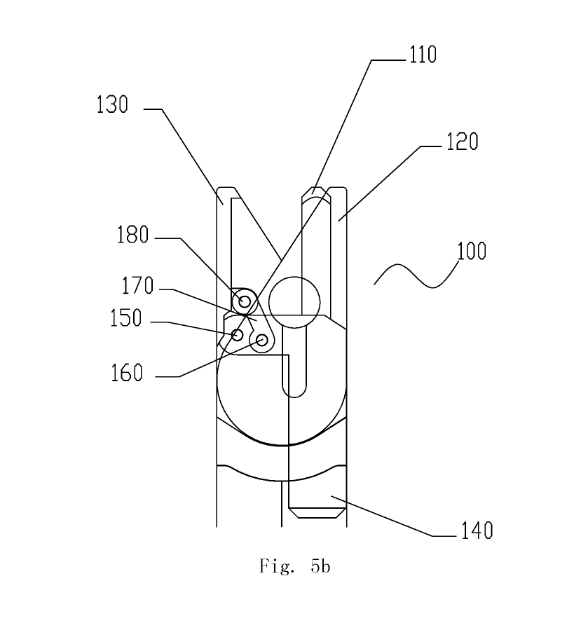

More specially, in the structure of the plug device according to the preferred embodiment of the present disclosure, as shown in FIGS. 4a, 4b, 5a and 5b, a second articulating shaft 150 capable of allowing the rotation of the movable pin 140 is disposed in a bottom of the movable pin 140, and the second articulating shaft 150 is fixed on a lower side of the pin module 101 through an articulation shaft fixing part 151. When the pin module 101 is provided with two fixed pins, a groove 152 for fixing the articulation shaft fixing part 151 may be provided between the two fixed pins (the articulation shaft fixing part 151 and the groove 152 are only illustrated in FIGS. 4a and 4b), and as shown in FIG. 5a and FIG. 5b. A third articulating shaft 160 is disposed in the movable pin 140 at a predetermined distance from the position of the second articulating shaft 150, and a pull tab 170 is also provided. The pull tab 170 has a first end articulated with a fourth articulating shaft 180 in an inner sidewall of the second casing, and a second end articulated with the second articulating shaft 160.

Thus, when the two casings 120, 130 are unfolded, the second casing 130 drives the movable pin 140 to turn. The movable pin 140 itself is configured to be L-shaped, the second articulating shaft 150 and the third articulating shaft 160 are both disposed in an end of the bottom of the L-shaped movable pin 140. The end of the movable pin 140 is turned downward and received into the slot 121, as shown in FIG. 5b (FIGS. 5a and 5b are perspective views, which cannot be really seen). Accordingly, when the two casings 120, 130 are unfolded towards two sides, the second casing drives the movable pin 140 to turn about the second articulating shaft 150 thereof through the pull tab 170 and the third articulating shaft 160, such that the movable pin 140 may be easily turned. When an elastic force is added, the structure may be unfolded automatically.

Preferably, as shown in FIGS. 4a and 4b, an elastic element 180 around the first articulating shaft 102 is further disposed between the first casing 120 and the second casing 130, and an elastic restoring force of the elastic element 180 is used to unfold the first casing 120 and the second casing 130. Specifically but not limited, the elastic element 180 is configured as a coil spring, and two elastic elements 180 are provided and located at two sides of the first articulating shaft and between the first casing 120 and the second casing 130, and two legs of each elastic element 180 are fixed on the first casing 120 and the second casing 130 respectively, to drive the two casings to be unfolded. The two casings may be unfolded automatically and the movable pin may be turned out due to the provision of the structures of the elastic element 180 and the above pull tab 170, such that an available plug state is formed.

In order to control the first casing 120 and the second casing 130 to switch from the folded state to the unfolded state, a button 190 is disposed on a sidewall of the first casing 120, as shown in FIGS. 4a and 4b, and preferably, two buttons 190 are provided at two sides respectively. A press portion 191 is disposed at a bottom surface of the button 190, and a resilient snap protrusion 192 fitted with the press portion 191 is disposed at a corresponding position of the second casing 120. A window 193 is disposed in the first casing 120, such that the press portion 191 may enter the window 193 and may be fitted with the resilient snap protrusion 192. The resilient snap protrusion 192 in an initial state protrudes under the action of resilience and extends to a snap step in the window 193, in which case the first casing 120 and the second casing 130 are fitted with each other, i.e. in the folded state. When the button 190 is pressed, the press portion 191 presses the resilient snap protrusion 192, such that the resilient snap protrusion 192 departs and retracts from the snap step in the window 193, and the two casings may be freely and relatively smoothly rotated and unfolded.

Accordingly, in the preferred embodiment of the plug device according to the present disclosure, under cooperation of structures such as the button 190, the elastic element 180 and the pull tab 170 and so on, when the elastic element 180 has sufficient elastic restoring force, the plug device according to the present disclosure may automatically achieve the unfolded state under the action of the sufficient elastic restoring force of the elastic element 180 after the button 190 is pressed. The practical effect thereof is amazing, and the whole plug device may be unfolded by only one hand.

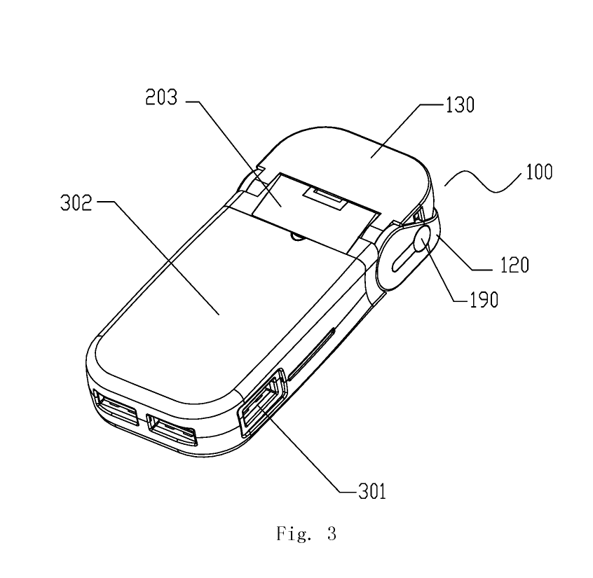

In another preferred embodiment of the fuse structure for the plug device according to preferred embodiments of the present disclosure, as shown in FIGS. 2a and 2b, a power output cable 300 and a plug of other corresponding type are connected to a rear end of the plug device. An accommodating portion 302 for a mobile power supply is further disposed in the body and below the fuse structure, and two USB power outputs 301 may be disposed in the bottom at the same time or separately. In an embodiment of the plug device according to the present disclosure shown in FIG. 3, a plurality of USB power outputs is disposed in the rear end thereof. For example, three USB power outputs are provided, in addition to the two disposed in the bottom, and the other one is further disposed in a side. Certainly, when the USB power output is adopted in the respective preferred embodiment according to the present disclosure, a management and control circuit also needs to be provided, which is well known by those skilled in the art, and will not described in detail herein.

It should be understood that, improvements and changes can be carried out by those skilled in the art, and all the improvements and changes are intended to be within the scope of the accompanying claims of the present disclosure.

1. A fuse structure for a plug device, disposed in a body of the plug device and configured to be electrically connected to a plug circuit of the plug device, the plug device comprising at least one casing for exposing a pin, wherein an assembly chamber for a fuse and a cover are disposed below the casing, a horizontal slot for the fuse is disposed in the fuse assembly chamber, and the cover is configured to cover the assembly chamber for the fuse; a pivot shaft of the cover is disposed adjacent to an articulating shaft of the casing, and the cover is prevented from being opened by the casing when the casing is unfolded.

2. The fuse structure according to claim 1, wherein the plug device further comprises a pin module having at least one fixed pin and disposed in an inserting direction; the articulating shaft of the casing is configured to be a first articulating shaft disposed in a bottom of the pin module, and the casing is configured to have two casings, including a first casing and a second casing, disposed to two sides of the pin module and rotatable about the first articulating shaft; a slot is disposed in a middle portion of the first casing, a movable pin corresponding to the fixed pin is disposed to the second casing, and the movable pin is configured such that the movable pin is located in the slot when the two casings are folded, and the movable pin is turned out of the slot when the two casings are unfolded, to form a plug cooperating with the fixed pin.

3. The fuse structure according to claim 2, wherein a rotatable second articulating shaft is disposed in a bottom of the movable pin, a third articulating shaft is disposed at a predetermined distance from the second articulating shaft, and a pull tab articulated with the third articulating shaft is disposed at an inner sidewall of the second casing; the movable pin is L-shaped, and the second articulating shaft and the third articulating shaft are located in an end of a bottom of the L-shaped movable pin.

4. The fuse structure according to claim 3, wherein the pull tab is connected to the inner sidewall of the second casing through a fourth articulating shaft.

5. The fuse structure according to claim 3, wherein two fixed pins are provided, and the fixed pins and the movable pin are configured as BS pins of Hong Kong standard.

6. The fuse structure according to claim 3, wherein an elastic element for unfolding the first casing and the second casing is disposed around the first articulating shaft between the first casing and the second casing.

7. The fuse structure according to claim 6, wherein the elastic element is configured as a coil spring, and two legs of the elastic element are fixed on the first casing and the second casing, respectively.

8. The fuse structure according to claim 6, wherein a button is disposed on a sidewall of the first casing, and configured to release a snap-fit structure for folding the first casing and the second casing when pressed; the snap-fit structure includes a resilient snap protrusion at a corresponding position of the second casing, and a press portion on a bottom surface of the button and configured to be fitted with the resilient snap protrusion.

9. The fuse structure according to claim 8, wherein the plug device is further provided with a power storage unit.

10. The fuse structure according to claim 8, wherein the plug device is further provided with at least one USB power output.
